(19) United States
(12) Patent Application Publication
(10) Pub. No.: US 2019/0051439 A1
(43) Pub. Date: Feb. 14, 2019

(54) SOLENOID VALVE

(71) Applicant: Robert Bosch GmbH, Stuttgart (DE)

(72) Inventors: Christian Langenbach, Erbstetten (DE); Andreas Dutt, Stuttgart (DE); Holger Rapp, Ditzingen (DE); Stefan Kolb, Gaertringen (DE); Tobias Landenberger, Schorndorf (DE); Francesco Lucarelli, Stuttgart (DE); Gernot Repphun, Balingen (DE); Markus Grieg, Gerlingen (DE); Steffen Holm, Stuttgart (DE)

(21) Appl. No.: 16/080,136

(22) PCT Filed: Jan. 3, 2017
(86) PCT No.: PCT/EP2017/050068

§ 371 Date: Aug. 27, 2018

(30) Foreign Application Priority Data
Feb. 26, 2016 (DE) 10 2016 203 083.3

(51) Int. Cl. H01F 7/08; F02M 63/00; F02M 59/36; F16K 31/06

(52) U.S. Cl. CPC H01F 7/081; F02M 63/0017; F02M 59/368; F16K 31/0675; H01F 2007/086; F02M 2200/02; F02M 2200/03; F02M 2200/08; F16K 31/0693

(57) ABSTRACT

The invention relates to a solenoid valve having an actuator body (17), in which a magnet coil (15) that interacts with a magnet core (16) is arranged and which interacts with an armature (14) that can be moved relative to the magnet core between two end positions and is acted upon by the spring force of an armature spring (13) in a movement direction pointing away from the magnet core (16). The magnet core and the armature have stop surfaces (18a, 18b) which are interrupted by a recess (29) that receives the armature spring. According to the invention, a solenoid valve is provided which is improved with respect to the function of the solenoid valve and the stress on the stop surfaces (18a, 18b) that causes wear. This is achieved in that the magnet core (16) and/or the armature (14) have/has a design (30, 31), in particular a spherical or toroidal design, which reduces the stress on the edges in the region of the stop surfaces (18a, 18b).

### BACKGROUND OF THE INVENTION

The present invention relates to a solenoid valve having a valve body, in which a magnet coil is arranged which interacts with a magnet core, and which interacts with an armature that can be moved relative to the magnet core between two end positions and is acted upon by the spring force of an armature spring in a movement direction pointing away from the magnet core, and wherein the magnet core and the armature have stop surfaces which are interrupted by a recess that receives the armature spring.

Such a solenoid valve is known from DE 10 2013 218 953 A1. This solenoid valve is designed as an electromagnetic suction valve of a high-pressure fuel pump, whereby the amount of fuel apportioned to a pump working chamber of the high-pressure fuel pump is adjusted with the electromagnetically actuated suction valve. For this, the solenoid valve in the known design comprises an actuator body, in which a magnet coil is arranged which interacts with a magnet core, which interacts with an armature that can be moved relative to the magnet core between two end positions. The armature is acted upon here by an armature spring, which forces the armature away from the magnet core. The armature spring is arranged in a recess made in the magnet core and the armature. The magnet core and the armature have stop surfaces enclosing the recess, which interact in one end position of the armature relative to the magnet core.

The problem which the invention proposes to solve is to provide a solenoid valve which is improved in regard to its function and a wear-causing stress.

### SUMMARY OF THE INVENTION

This problem is solved in that the magnet core and/or the armature has (have) a rounded configuration which reduces an edge stress in the region of the stop surfaces. This configuration is based on the understanding that such a solenoid valve has potential for improvement in regard to various parameters. On the one hand, when a voltage is applied to the magnet coil a magnetic force is produced, which attracts the armature against the spring force of the armature spring until it comes to bear against the magnet core. If, now, the energizing is halted, the armature should detach from the magnet core as quickly as possible and perform a desired switching function. This rapid detachment is impaired in the case of a fluid-filled solenoid valve by an adhesive effect (hydraulic adhesion) of the armature on the magnet core. On the other hand, the armature at the state of rest in which it is moved by the armature spring away from the magnet core may have a slightly skewed position relative to the magnet core. This skewed position initially cause the armature in a subsequent switching process, which is established by an energizing of the magnet core, to strike the magnet core in a skewed position and thereby cause a stress on the edges in the area of the initially touching stopping surfaces of the armature and the magnet core, which may cause wear in this region. Now, thanks to the rounded configuration of the stopping surfaces, both the edge stress is prevented and a hydraulic adhesion effect of the armature against the magnet core is avoided during a subsequent detachment process of the armature from the magnet core by halting the energizing of the magnet core. Thus, thanks to the configuration according to the invention the switching accuracy of the solenoid valve is improved, while at the same time a possible wear can be significantly decreased or eliminated.

In one modification of the invention, the magnet core and/or the armature has (have) a convex configuration in the region of at least one stopping surface. The convex configuration extends over the entire stopping surface of the magnet core and/or the armature and is only interrupted by the recess.

In one modification of the invention, the magnet core and/or the armature has (have) a toroidal configuration in the region of at least one stopping surface. This configuration may likewise be combined with a convex configuration. Both configurations ensure that no edge stress will occur and also adhesion effects are prevented at the same time.

In another embodiment of the invention, the stopping surfaces of the magnet core and of the armature have a convex/convex configuration combination. Alternatively, in another embodiment it is also provided that the stopping surfaces of the armature and of the magnet core have a convex/concave or concave/convex configuration combination. In any case, the edge stress in the latter configuration combination is reduced or eliminated, while furthermore no hydraulic adhesion effect occurs either thanks to an appropriate combination of the convex or concave configuration of the stopping surfaces, since the degree of convexity and concavity can be chosen to be different. In this regard, it should be pointed out specifically that the rounded configuration of one stopping surface (i.e., either that of the magnet core or that of the armature) also includes the possibility that the second stopping surface is configured so as to be flat. This possibility is provided for all the embodiments mentioned above.

In one modification of the invention, the rounded configuration of the stopping surfaces has a dimension B causing no edge stress in a maximum skewed position of the armature relative to the magnet core. This optimizes the function of the solenoid valve in regard to the forces and stresses occurring for the solenoid valve.

In one modification of the invention, the rounded configuration has a rounding dimension B of 30 μm to 500 μm, preferably in the range of 50 μm to 300 μm. Within these specified values, it is normally ensured that the mentioned problems cannot occur. These values are especially suitable for a solenoid valve which is used in a high-pressure fuel pump as mentioned below. In particular, other rounding dimensions are also possible in other applications in the context of the invention.

In another embodiment of the invention, the stopping surfaces are hardened. Since both the magnet core and the armature are made of a metallic material in order to generate and propagate the magnetic fields, among other things, a hardening is possible with no problems.

In one modification of the invention, a high-pressure fuel pump with a solenoid valve designed as an electromagnetic suction valve is provided. This is the preferred application, although other applications are also possible in the context of the invention. The electromagnetic suction valve of the high-pressure fuel pump designed according to the invention, especially that of a common-rail injection system, ensures a trouble-free operation over a period encompassing the service life of the high-pressure fuel pump during normal operation.

### BRIEF DESCRIPTION OF THE DRAWINGS

Further advantageous embodiments of the invention will be found in the description of the drawings, in which sample embodiments represented in the figures are described more closely.

There are shown:

FIG. 1, a longitudinal section through a pump cylinder head region of a high-pressure fuel pump, which is outfitted with a solenoid valve designed as an electromagnetic suction valve,

FIG. 2, a detail view of the stopping surfaces of a magnet core and of an armature of a solenoid valve with a convex configuration,

FIG. 3, a detail view of the stopping surfaces of a magnet core and an armature of a solenoid valve, where the armature has a toroidal configuration,

FIG. 4, a detail view of the stopping surfaces of a magnet core and of an armature of a solenoid valve, where both contact surfaces have a toroidal configuration, and

FIG. 5, a detail view of the contact surfaces of a magnet core and of an armature of a solenoid valve, where the magnet core has a toroidal convex configuration and the armature has a toroidal concave configuration.

### DETAILED DESCRIPTION

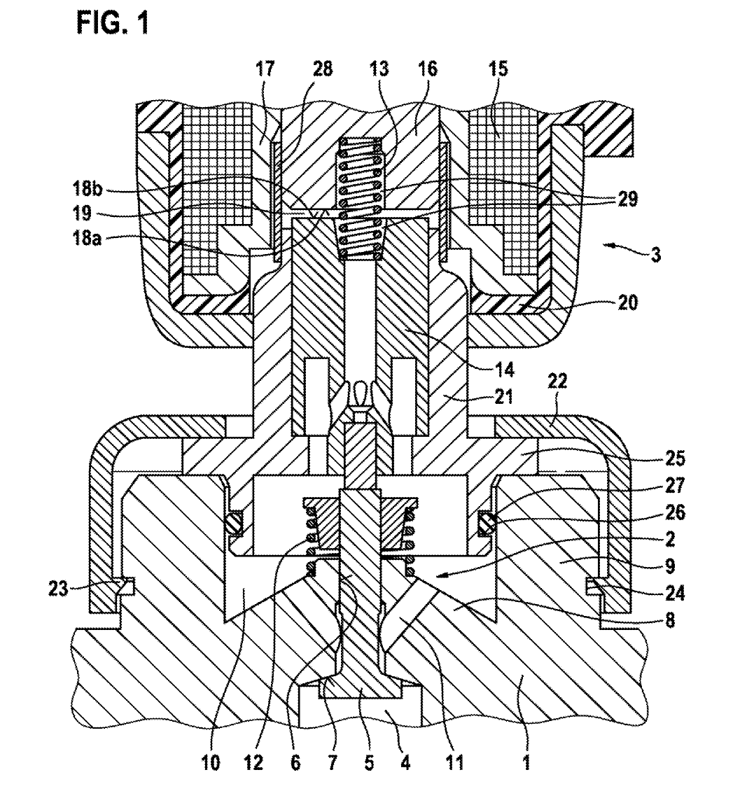

The high-pressure fuel pump shown partly in longitudinal section in FIG. 1 comprises a pump cylinder head 1, in which a solenoid valve is integrated. The solenoid valve comprises an electromagnetically actuatable suction valve 2, which is activated by a solenoid actuator 3. The suction valve 2 serves for the filling of a pump working chamber 4 of the high-pressure fuel pump with fuel. The suction valve 2 comprises a valve tappet 5, which is received and guided with a lifting movement in a bore 6 of the pump cylinder head 1. The pump cylinder head 1 moreover forms a valve seat 7, which interacts in a sealing manner with a valve disk of the valve tappet 5.

In the region of the bore 6 the pump cylinder head 1 of the high-pressure fuel pump comprises a conical elevation 8, surrounded by a collar 9. The collar 9 is part of the pump cylinder head 1 and bounds a low-pressure chamber 10, which is connected by inlet bores 11 to the bore 6. Hence, the low-pressure chamber 10 is part of a fuel flow path.

The valve tappet 5 with the valve disk of the suction valve 2 opens directly into the pump working chamber 4. In the closing direction, the valve tappet 5 is subjected to the spring force of a valve spring 12, which is braced on the one hand against the valve tappet 5 or a supporting piece interacting with it and on the other hand against the pump cylinder head 1 in the region of the elevation 8. The spring force of the valve spring 12 is chosen to be less than the spring force of an armature spring 13, which applies force to an armature 14 of the solenoid actuator 3 which can be coupled to the valve tappet 5 and is braced for this purpose against a magnet core 16. The armature spring 13 is installed here in a recess 29 made in the magnet core 16 and the armature 14. The spring force of the armature spring 13 is opposed by the spring force of the valve spring 12, so that the valve spring 12 cannot close the suction valve 2 when the armature spring 13 presses the armature 14 against the valve tappet 5.

In order to overcome the spring force of the armature spring 13 and close the suction valve 2, the solenoid actuator 3 is provided, comprising a ring-shaped magnet coil 15 and the magnet core 16 placed therein. The magnet core 16 and the magnet coil 15 are installed in an actuator body 17. The magnet core 16 and the armature 14 have stopping surfaces 18a, 18b facing each other and surrounding the recess 29, enclosing a working air gap 19. The configurations of the stopping surfaces 18a, 18b according to the invention shall be explained in further detail in the following figures.

If the magnet coil 15 is energized, the armature 14 moves in the direction of the magnet core 16 in order to close the working air gap 19, whereupon the stopping surfaces 18a, 18b of the magnet core 16 and of the armature 14 come into contact. The movement of the armature 14 brings about a relieving of the load on the valve tappet 5, so that the valve spring 12 presses the valve tappet 5 into the valve seat 7. The suction valve 2 closes. For the opening of the suction valve 2, the energizing of the magnet coil 15 is halted and the spring force of the armature spring 13 returns the armature 14 and the valve tappet 5 to the respective opened starting position of the suction valve 2.

The solenoid actuator 3, which is surrounded by an encapsulation 20 for electrical insulation and for sealing against the surroundings, is fixed in the actuator body 17 and the latter is fixed by a guide sleeve 21 on the pump cylinder head 1 of the high-pressure fuel pump. This fixation is done by a cap 22, which is placed on the guide sleeve 21 connected to the solenoid actuator 3 and joined by form fitting to the collar 9 of the pump cylinder head 1. The cap 22 for this purpose has an encircling detent lug 23, pointing radially inward and engaging with an annular groove 24 of the collar 9 arranged on the outer circumference. The guide sleeve 21 on which the cap 22 is placed has an encircling flange 25 arranged on the outer circumference for the bracing of the cap 22, whereby the guide sleeve 21 is furthermore braced against the collar 9. The flange 25 arranged so as to be is set back so that a portion of the guide sleeve 21 protrudes into the collar 9. This portion has an annular groove 26 on the outer circumference, in which a sealing element 27 is installed. The sealing element 27 lies under prestressing against the inner circumference of the collar 9, so that a sealing off of the low-pressure chamber 10 is accomplished in this way.

The guide sleeve 21 serves for the receiving and guiding of the armature 14. It is connected by a sleeve 28 to the magnet core 16 of the solenoid actuator 3. For this, the sleeve 28 is placed on the one hand on the guide sleeve 21, and on the other hand on the magnet core 16, and it is welded to the latter, for example. For the magnetic separation of the guide sleeve 21 from the magnet core 16, the sleeve 28 is made of a nonmagnetic material. The junction area lies inside the encapsulation 20.

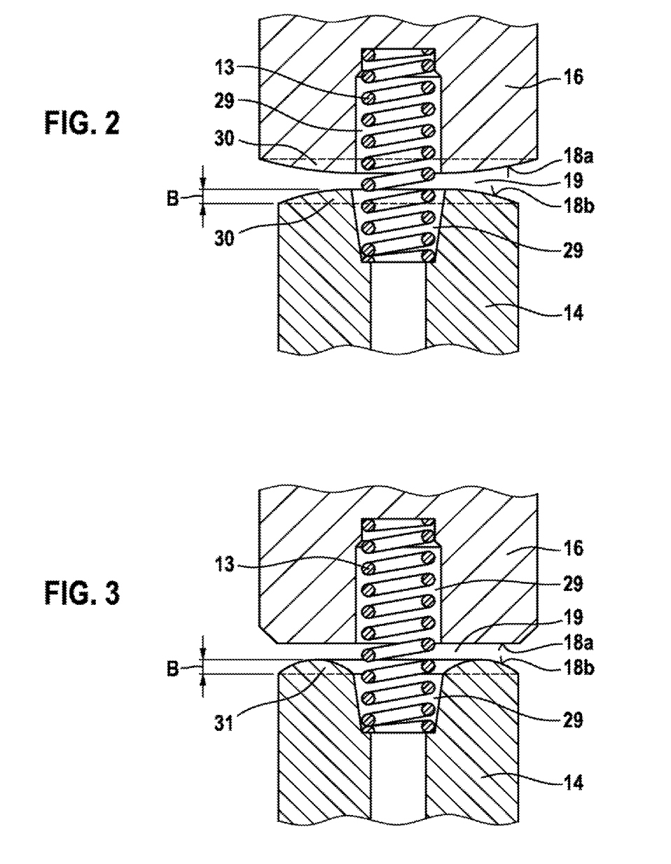

FIG. 2 shows a detail view of the mutually facing stopping surfaces 18a, 18b of the magnet core 16 and the armature 14. The recess 29 receiving the armature spring 13 is made in the magnet core 16 and the armature 14, passing between them. Starting with the planar configuration of the stopping surfaces 18a, 18b as shown in FIG. 1, FIG. 2 shows a convex configuration 30 of both the magnet core 16 and the armature 14. The dimension B of the convex configuration 30 is preferably designed here such that no edge stress occurs at the stopping surfaces 18a, 18b in the event of a possible skewed position of the armature 14 relative to the magnet core 16 in the outer circumferential region of the mentioned components.

By contrast with this, in the configuration of FIG. 3 the stopping surface 18a of the magnet core 16 is formed so as to be planar, while the stopping surface 18b of the armature 14 has a toroidal configuration 31. The dimension B of the convex configuration 30 or the toroidal configuration 31 here lies preferably in the range of approximately 50 μm to approximately 300 μm.

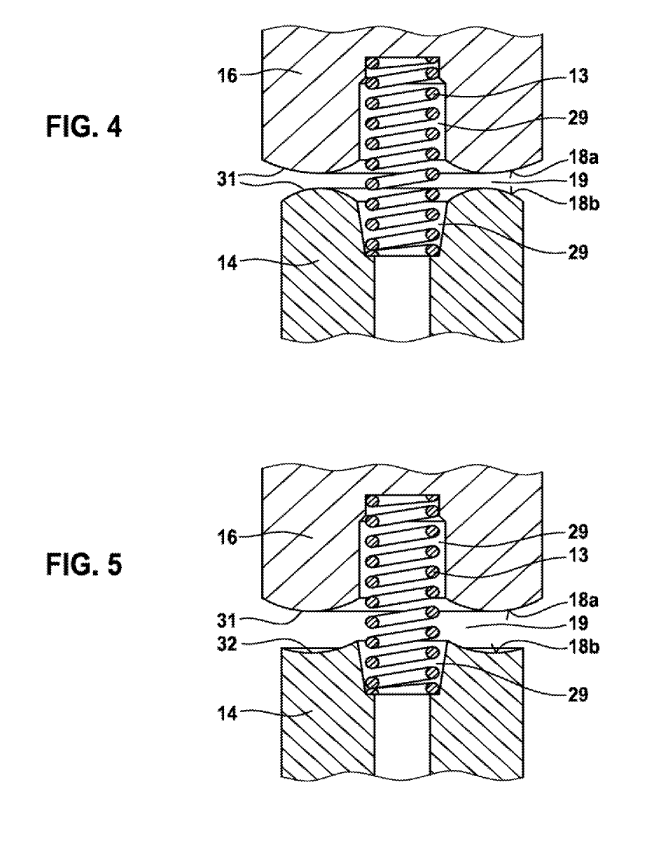

FIG. 4 shows, by contrast with the embodiment of FIG. 3, a toroidal configuration 31 of both the magnet core 16 and the armature 14. Consequently, the stopping surfaces 18a, 18b of the armature 14 and the magnet core 16 has a convex/convex combination here.

In the embodiment of FIG. 5, the magnet core 16 again has a toroidal configuration 31 of the stopping surface 18a, while the stopping surface 18b of the armature 14 has a concave configuration 32 adapted to the toroidal configuration 31 (or vice versa). The degree of convexity or concavity may be the same or different. In particular, the degree of convexity may be less than the degree of concavity, so that it is ensured that no edge stress occurs even under unfavorable conditions with regard to a skewed position of the armature 14 with respect to the magnet core 16.

In conclusion, it is noted that any individual features described for the invention may be combined with each other and among each other.

1. A solenoid valve comprising an actuator body (17), having arranged therein a magnet coil (15) which interacts with a magnet core (16), and which interacts with an armature (14) that can be moved relative to the magnet core (16) between two end positions, wherein the armature is acted upon by the spring force of an armature spring (13) in a movement direction pointing away from the magnet core (16), and wherein the magnet core (16) and the armature (14) have stop surfaces (18a, 18b) which are interrupted by a recess (29) that receives the armature spring (13), characterized in that at least one of the magnet core (16) and the armature (14) has a rounded configuration (30, 31, 32) which reduces a stress on edges in a region of the stop surfaces (18a, 18b).

2. The solenoid valve as claimed in claim 1, characterized in that the magnet core (16) and/or the armature (14) has a convex configuration (30) in the region of at least one stopping surface (18a, 18b).

3. The solenoid valve as claimed in claim 1, characterized in that the magnet core (16) and/or the armature (14) has a toroidal configuration (31) in the region of at least one stopping surface (18a, 18b).

4. The solenoid valve as claimed in claim 1, characterized in that the stopping surfaces (18a, 18b) of the magnet core (16) and of the armature (14) have a convex/convex configuration combination.

5. The solenoid valve as claimed in claim 1, characterized in that the stopping surfaces (18a, 18b) of the magnet core (16) and of the armature (14) have a convex/concave configuration combination.

6. The solenoid valve as claimed in claim 1, characterized in that the configuration (30, 31, 32) has a dimension B causing no edge stress on the stopping surfaces (18a, 18b) in a maximum skewed position of the armature (14) relative to the magnet core (16).

7. The solenoid valve as claimed in claim 1, characterized in that the configuration (30, 31, 32) has a dimension B of 50 μm to 300 μm.

8. The solenoid valve as claimed in 1, characterized in that the stopping surfaces (18a, 18b) are hardened.

9. A high-pressure fuel pump with a solenoid valve as claimed in claim 1.

10. The solenoid valve as claimed in claim 1, wherein the magnet core (16) has a rounded configuration which reduces the stress on edges in the region of the stop surfaces.

11. The solenoid valve as claimed in claim 1, wherein the armature (14) has a rounded configuration which reduces the stress on edges in the region of the stop surfaces.

12. The solenoid valve as claimed in claim 11, wherein the magnet core (16) also has a rounded configuration which reduces the stress on edges in the region of the stop surfaces.
